(19) United States
(12) Patent Application Publication
(10) Pub. No.: US 2006/0148482 A1
(43) Pub. Date: Jul. 6, 2006

(54) Coordinating radio resource usage in unlicensed frequency bands

(75) Inventor: Stefan Mangold, Ossining, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/559,901

(22) PCT Filed: Jun. 15, 2004
(86) PCT No.: PCT/IB04/50914

§ 371 Date: Dec. 8, 2005

Related U.S. Application Data
(60) Provisional application No. 60/479,234, filed on Jun. 17, 2003.
(60) Provisional application No. 60/523,392, filed on Nov. 19, 2003.

(51) Int. Cl. H04Q 7/20

(52) U.S. Cl. 455/450; 455/454

(57) ABSTRACT

A system and method for coordinating radio resource usage in an unlicensed frequency band (24) is provided. Specifically, under the present invention, a set of spectrum etiquette rules is provided that govern how radio systems (20A-C) operate within unlicensed frequency bands (24). In a typical embodiment, the set of spectrum etiquette rules can accommodate radio systems (20A-C) operating at varying channel bandwidths. To this extent, the set of spectrum etiquette rules generally includes: a channel switching rule; a bandwidth selection rule; a power selection rule; a deferring listen before talk (LBT) rule; a channelized LBT rule; and a synchronized LBT rule.

The present invention generally relates to a system and method for coordinating radio resource usage in unlicensed frequency bands. Specifically, the present invention provides a set of spectrum etiquette rules for governing how radio systems operate within an unlicensed frequency band.

The usage of the radio spectrum and the regulation of radio emissions are coordinated by national regulatory bodies. As part of radio regulation, the radio spectrum is divided into frequency bands, and licenses for the usage of frequency bands are provided to operators, typically for an extended period of time such as one or two decades. In general, different frequency bands are assigned to different types of radio services. Typical radio services include, for example, radio-navigation and radio-location, mobile communication, and TV-broadcasting. An operator that has been given a license has typically the exclusive right to use the respective radio resources for providing radio services. Therefore, the operator does not have to share radio resources (frequency channels at certain places and time) with other operators. Because of the exclusive right to use radio resources, such radio services are referred to as primary radio services. Similarly, radio systems providing primary radio services are referred to as primary radio systems. In general, a radio system represents a group of communicating devices, for example a group of communicating wireless stations in a wireless LAN.

Since operators within the licensed frequency bands often have the exclusive right to use the radio resources of the assigned bands for providing radio services, these frequency bands may be used inefficiently. This is not in the interest of the regulatory bodies, because they attempt to achieve high efficiency in the usage of radio resources. An alternative way of regulation is to coordinate the usage of the radio spectrum with unlicensed frequency bands. Within unlicensed frequency bands, radio systems coordinate the usage of radio resources autonomously while operating. To this extent, unlicensed radio services are referred to as secondary radio services, while radio systems providing secondary radio services are referred to as secondary radio systems.

With this approach, however, the problem that arises is how to achieve efficient resource sharing between the unlicensed radio systems that are competing for radio resources. Specifically, future radio communication systems will have to support high data rates under Quality-of-Service (QoS) requirements such as reliability, and delay constraints. Unlicensed frequency bands are candidates for a large set of radio services because of their public availability. However, unlicensed frequency bands may be efficiently used only when the usage of the radio resources is clearly coordinated. Unfortunately, no existing system provides for coordination of radio resource usage for unlicensed frequency bands.

In view of the foregoing, there exists a need for a system and method for coordinating radio resource usage in unlicensed frequency bands. Specifically, a need exists for a set of spectrum etiquette rules that can help govern radio resource usage by radio systems in an unlicensed frequency band. A further need exists for the set of spectrum etiquette rules to be able to accommodate multiple radio systems operating at varying frequency channel bandwidths.

In general, the present invention provides a system and method for coordinating radio resource usage in an unlicensed frequency band. Specifically, under the present invention, a set of spectrum etiquette rules is provided that governs how radio systems operate within the unlicensed frequency band. In a typical embodiment, the set of spectrum etiquette rules can accommodate radio systems operating at varying channel bandwidths. To this extent, the spectrum etiquette rules generally include: (1) a channel switching rule for determining a frequency channel of operation for a radio system based on a proximity of the frequency channel of operation to an in-use frequency channel of operation; (2) bandwidth selection rule for limiting a bandwidth consumption of a radio system to a reference channel bandwidth based on a bandwidth requirement of the radio system; (3) a power selection rule for limiting a power consumption of a radio system to a predetermined level based on the bandwidth consumption of the radio system; (4) a deferring listen before talk (LBT) rule for requiring a radio system to scan for an open frequency channel before communicating; (5) a channelized LBT rule for requiring a radio system to scan all frequency channels within a reference channel bandwidth before communicating; and (6) a synchronized LBT rule for requiring a radio system to synchronize a LBT process in time across neighboring frequency channels within the reference channel bandwidth.

A first aspect of the present invention provides a system for coordinating radio resource usage in an unlicensed frequency band, comprising: a plurality of radio systems operating in the unlicensed frequency band; and a set of spectrum etiquette rules for coordinating radio resource usage by the plurality of radio systems, wherein the set of spectrum etiquette rules includes a channel switching rule for determining a frequency channel of operation for at least one of the plurality of radio systems based on a proximity of the frequency channel of operation to an in-use frequency channel of operation that is associated with the at least one of the plurality of radio systems.

A second aspect of the present invention provides a system for coordinating radio resource usage in an unlicensed frequency band, comprising: a plurality of radio systems, wherein the plurality of radio systems includes a reference channel radio system, a narrow channel ratio system and a wide channel radio system, and wherein a reference channel bandwidth is defined based on the reference channel radio system; and a set of spectrum etiquette rules for coordinating radio resource usage by the plurality of radio systems, wherein the set of spectrum etiquette rules includes a channel switching rule for determining a frequency channel of operation for the narrow channel radio system based on a proximity of the frequency channel of operation to an in-use frequency channel of operation that is associated with the narrow channel radio system.

A third aspect of the present invention provides a method for coordinating radio resource usage in an unlicensed frequency band, comprising: defining a reference channel bandwidth based on a reference channel radio system; and determining a frequency channel of operation for a narrow channel radio system based on a proximity of the frequency channel of operation to an in-use frequency channel of operation that is associated with the narrow channel radio system.

Therefore, the present invention provides a system and method for coordinating radio resource usage in an unlicensed frequency band.

These and other features of this invention will be more readily understood from the following detailed description of the various aspects of the invention taken in conjunction with the accompanying drawings in which:

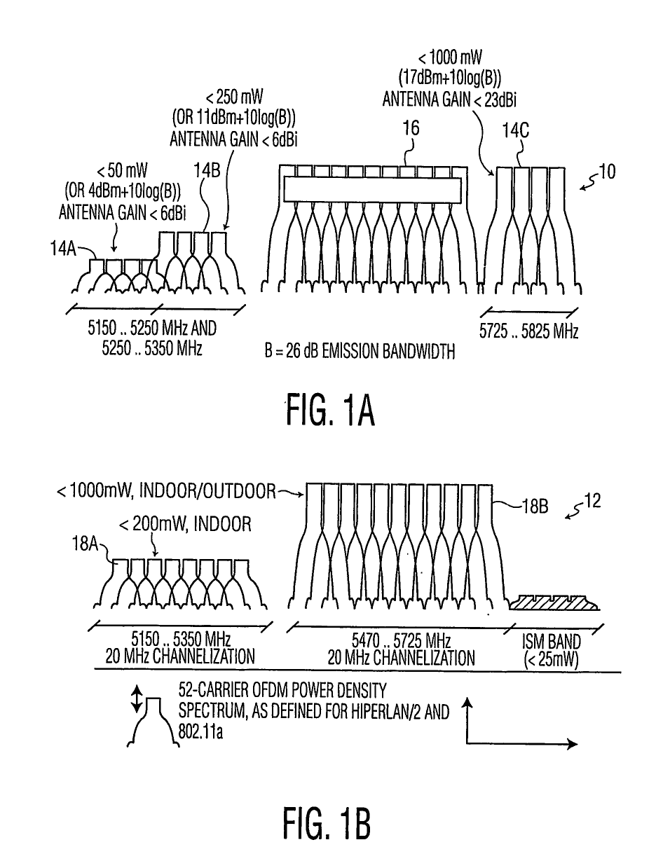

FIG. 1 depicts an illustrative unlicensed 5 GHz frequency band for wireless local area networks (LANs) in the United States and Europe.

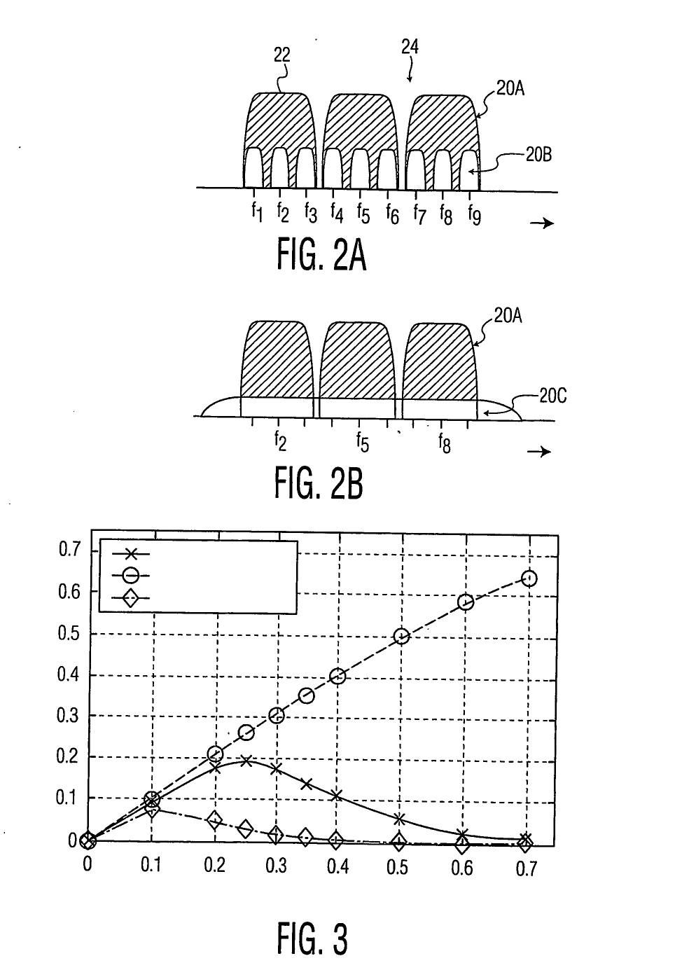

FIG. 2 depicts an illustrative unlicensed frequency band used by three different types of radio systems.

FIG. 3 depicts an illustrative graph of average resulting channel usage per radio system with all three radio systems utilizing the listen before talk (LBT) rule of the present invention.

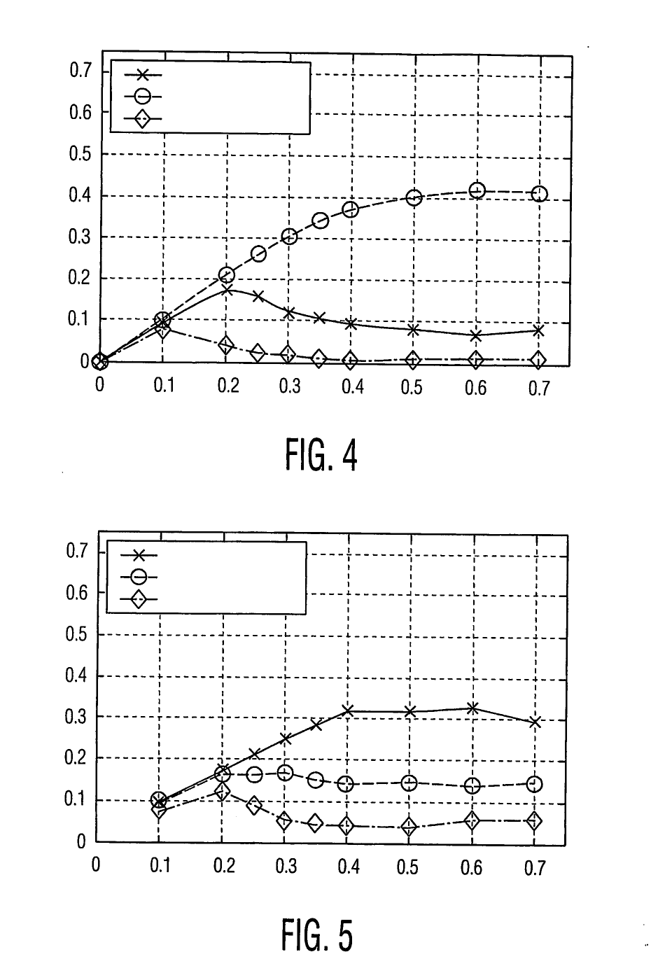

FIG. 4 depicts an illustrative graph of resulting airtimes of the three radio systems when the channelized LBT rule of the present invention is utilized.

FIG. 5 depicts an illustrative graph of resulting airtimes of the three radio systems when the synchronized LBT rule of the present invention is utilized.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

As indicated above, the present invention provides a system and method for coordinating radio resource usage in an unlicensed frequency band. Specifically, under the present invention, a set of spectrum etiquette rules is provided that governs how radio systems operate within the unlicensed frequency band. In a typical embodiment, the set of spectrum etiquette rules can accommodate radio systems operating at varying channel bandwidths. To this extent, the spectrum etiquette rules generally include: (1) a channel switching rule for determining a frequency channel of operation for a radio system based on a proximity of the frequency channel of operation to an in-use frequency channel of operation; (2) bandwidth selection rule for limiting a bandwidth consumption of a radio system to a reference channel bandwidth based on a bandwidth requirement of the radio system; (3) a power selection rule for limiting a power consumption of a radio system to a predetermined level based on the bandwidth consumption of the radio system; (4) a deferring listen before talk (LBT) rule for requiring a radio system to scan for an open frequency channel before communicating; (5) a channelized LBT rule for requiring a radio system to scan all frequency channels within a reference channel bandwidth before communicating; and (6) a synchronized LBT rule for requiring a radio system to synchronize a LBT process in time across neighboring frequency channels within the reference channel bandwidth.

As further indicated above, regulatory bodies attempt to coordinate the usage of radio resources so that the most efficient usage is achieved. This is one of the reasons why unlicensed frequency bands have been introduced. Unlicensed frequency bands are parts of the radio spectrum in which any type of radio service is permitted, where any type of radio system that meets a predefined set of regulatory requirements can be used. Those requirements regulate, among other things, radio parameters such as limits of the radiated power, out of band emissions, and antenna characteristics. In contrast to the licensed approach, a diverse set of different radio systems may operate using the same radio resources in an unlicensed frequency band. The advantage of unlicensed frequency bands is that, provided that sharing of radio resources is feasible, available radio resources are used more frequently and at more locations, which may lead to better efficiency.

Typically, unlicensed frequency bands cover Industrial, Scientific and Medical (ISM) bands such as the 2.4 GHz band, and Unlicensed National Information Infrastructure (U-NII) bands (in the United States), such as the 5 GHz band. The difference between ISM and U-NII bands is that radio systems operating in U-NII bands mainly provide communication services, whereas in ISM bands any type of radio system may operate. That is, radio systems that operate in ISM bands must not necessarily provide communication services. For example, microwave ovens may radiate energy in ISM bands. The primary radio services in the 5 GHz band are radio-navigation and radio-location. The regulatory requirements for secondary radio systems are defined such that the primary radio systems can still operate in the presence of interference from secondary radio systems.

The 5 GHz unlicensed frequency band covers the radio spectrum between 5.15 GHz and 5.825 GHz. FIG. 1 illustrates this frequency band as it is defined for the United States (represented by channels 10) and for Europe (represented by channels 12). It should be understood in advance that FIG. 1 is intended to represent an illustrative view of the 5 GHz frequency band. As such, the values shown therein could change. In any event, the channelization indicated in FIG. 1 refers to the Orthogonal Frequency Division Multiplexing (OFDM) transmission scheme as applied by wireless Local Area Networks (LANs). As shown, the band is practically harmonized across the two regions of channels 10 and 12. Moreover, under the IEEE 802.11(a) standard, channels 10 and 12 are considered to be non-overlapping (as opposed to channels within the 2.4 GHz ISM band, which can overlap). In the United States, three U-NII frequency bands 14A-C of contiguous spectrum are assigned between 5.15 GHz and 5.825 GHz, leading to twelve frequency channels of 20 MHz, which are currently used by wireless LANs. In total, a spectrum of 300 MHz has been released for the U-NII frequency band for secondary radio services. It is proposed, however, to add eleven more channels 16 (255 MHz between 5.47 GHz and 5.725 GHz) by the end of 2003.

In Europe, radio regulations permit the operation at nineteen 20 MHz frequency channels 18A-B within two bands of contiguous spectrum. In total, a spectrum of 455 MHz is available for the secondary radio services. Wireless LANs must use the complete band in order to share the spectrum with primary radio systems, with the help of dynamically selecting the frequency channel and the transmission powers. To allow the invention of less complicated radio systems, in the lower part of the spectrum, below 5.35 GHz, secondary radio systems are permitted to operate without implementing dynamic channel selection and power control, similar to the requirements in the United States. Higher antenna gains are permitted in Europe with the corresponding reduction of transmission power (the Equivalent Isotropically Radiated Power (EIRP) remains below a limit).

Unlicensed frequency bands such as the 5 GHz band shown in FIG. 1 are candidates for a large set of radio services. However, the usage of radio resources in unlicensed frequency bands should to be carefully regulated to allow as many radio systems as possible in the future to operate in such unlicensed bands. Because the radio spectrum is a finite and limited resource, spectrum efficiency must be achieved, and a fair share of resources among the radio systems must be provided. Accordingly, the present invention provides a set of spectrum etiquette rules for coordinating resource usage in unlicensed frequency bands such as that shown in FIG. 1. The set of spectrum etiquette rules defines the behavior of radio systems mainly in order to achieve multiple goals. First, if all radio systems follow the set of spectrum etiquette rules, fairness in access to the shared radio resources is maintained, and second, the frequency band is more efficiently used. In addition, the set of spectrum etiquette rules typically intends to mitigate unwanted mutual effects between radio systems that occur when radio systems operate without being aware of the ongoing operations of other radio systems. In any event, the set of spectrum etiquette rules under the present invention is defined independently of any specific radio system and aims to cover any possible transmission scheme (for example spread spectrum, Orthogonal Frequency Division Multiplex, OFDM, or Ultra Wideband, UWB) and any possible multiple access scheme (Time/Frequency/Code Division Multiple Access, T/F/CDMA, or Carrier Sense Multiple Access, CSMA). Thus, under the present invention, the set of spectrum etiquette rules are provided for ensuring that unlicensed frequency bands are efficiently used.

It should be understood that the set of spectrum etiquette rules does not define a protocol, and is not restricted to one radio standard. Further, the set of spectrum etiquette rules of the present invention is typically not an algorithm that describes the entire radio resource management of all radio systems. Rather, each radio system can apply its own algorithms within the constraints of the spectrum etiquette. The spectrum etiquette provides a framework for behaviors, which may restrict the degrees of freedom in radio resource management of the individual radio systems. Nevertheless, different algorithms applied by different radio systems will allow differentiation among them, even if the spectrum etiquette is used.

Referring now to FIG. 2, the usage of radio resources in a simplified model of an unlicensed frequency band 24 is depicted. Similar to FIG. 1, it should be understood that FIG. 2 is intended to be illustrative only, and that the teachings of the present invention could be implemented in conjunction with any type of unlicensed frequency band and/or arrangement of radio systems. In any event, FIG. 2 depicts three different types of radio systems 20A-C operating within unlicensed frequency band 24, each operating with different frequency channel bandwidths. Radio system 20A is considered to be a reference channel radio system and operates on three frequency channels (center frequencies f₂, f₅, f₈). Radio system 20A can be compared to wireless LANs operating in the 5 GHz band (using OFDM). As the reference channel system, radio system 20A defines a “reference frequency grid” that is used as a target channelization supported by the set of spectrum etiquette rules. To this extent, channel 22 of radio system 20A is considered to represent the reference channel bandwidth for radio systems 20A-C. Radio system 20B is considered to be a narrow channel radio system and operates on nine frequency channels (center frequencies f₁. . . f₉). For example, radio system 20B could represent narrowband radio systems supporting for example a limited number of voice calls. Radio system 20C is considered to be a wide channel radio system and operates on one frequency channel (center frequency f₅). For example, radio system 20C could represent radio systems that use broadband transmission schemes such as UWB operating in the unlicensed band or spread spectrum. Here, the terms “narrowband” and “broadband” are used in relation to the reference bandwidth. As further shown in FIG. 2, the frequency channels overlap with each other. It should be understood that the quantity and bandwidth of the frequency channels in FIG. 2 do not represent any existing unlicensed band and this usage model serves as an example model only

To coordinate radio resource usage among radio systems 20A-C, a set of spectrum etiquette rules are provided. There are various spectrum etiquette rules that can be defined for the three radio systems. Spectrum etiquette rules require mechanisms, in the following referred to as actions, to be provided by radio systems 20A-C. To this extent, a basic set of actions is defined in the following.

I. ACTION “TPS”: Transmission Power Selection

A radio system may operate with different transmission powers, depending on channel conditions and observed interferences. This is here referred to as Transmission Power Selection (TPS). The higher the transmission power, the higher the interference on other radio systems. However, communication will be less erroneous with increased transmission powers.

II. ACTION “CHS”: Channel Selection

A radio system may change the frequency channel it is operating on, based on channel conditions and observed interferences. This is here referred to as Channel Selection (CHS). Based on the decision taking process that determines when to select a new channel and which channel to select, CHS can be advantageous not only for the radio system that selects another channel, but also for all other radio systems.

III. ACTION “BWS”: Bandwidth Selection

In extension to what is indicated in FIG. 2, a radio system may select a different channel bandwidth depending on its radio services, and the channel conditions. This is here referred to as Bandwidth Selection (BWS). A radio system that applies BWS may be able to operate with any channelization indicated in the FIG. 2. BWS includes operating on multiple narrowband channels in parallel.

IV. ACTION “LBT”: Listen Before Talk

Listen Before Talk (LBT) is also known as CSMA, and is often discussed in the context of spectrum etiquettes. Radio systems that operate with LBT often achieve a fair sharing of radio resources to some extent With LBT, the control over the access to radio resources is distributed among the radio systems, and it is therefore difficult for the individual radio systems to determine if they will be able to support their radio services.

Under the present invention, taking an action such as those listed above is referred to as “behavior.” The action taking entity is a radio system (e.g., radio systems 20A-C). A spectrum etiquette rule is the instruction to a radio system 20A-C to select a particular behavior upon detecting a certain event. Before introducing the set of spectrum etiquette rules of the present invention, some underlying assumptions that are independent from the action space are discussed. As mentioned above, the channelization of radio system 20A determines a reference grid of frequency channels. Thus, the bandwidth of radio system 20A determines what is in the following referred to as the reference bandwidth. Rules that apply for radio systems that operate with a larger bandwidth such as radio system 20C may be different to rules that apply for radio systems with the reference bandwidth (radio system A) or a smaller bandwidth (radio system B). In general, the knowledge about the reference channelization and the reference bandwidth may be obtained from the history of past measurements or by using a predefined reference frequency grid, which is generally a priori known to all radio systems.

When scanning a frequency channel for interference, multiple neighboring frequency channels are typically scanned at the same time. By cross-correlating in time the measurement results of the different frequency channels, it can be estimated if other radio systems operate with a larger channel bandwidth than the measuring radio system. If the detected interference on neighboring narrowband frequency channels is correlated, it can be concluded that a radio system operates on all these frequency channels, by using the respective channels as one broadband frequency channel instead of multiple independent narrowband channels.

Radio systems 20A-C may dynamically modify their behavior to adapt to the environment. As a general assumption, when a radio system changes its behavior, it should behave so that it allows other radio systems that are competing for radio resources to estimate upcoming changes in its radio resource utilization. For example, a radio system may behave such that the history of its previously selected actions correlates with its current and future behavior. To this extent, it is assumed that radio systems 20A and 20B are capable of dynamically changing the frequency channel over a bandwidth larger than the reference bandwidth. In addition, radio system 20C should be able to dynamically select a frequency channel if the bandwidth of the complete unlicensed band is larger than its channel bandwidth. Using the four actions that are defined above and referred to as TPS, CHS, BWS, and LBT, the following rules may be considered as working assumption for a set of spectrum etiquette rules in unlicensed bands. All of the following rules may apply to sub-bands of the unlicensed frequency band, or for the complete unlicensed frequency band.

Rule #1 “Bandwidth Selection Rule”

A radio system supporting a radio service that requires a channel bandwidth not larger than the reference bandwidth should not operate with a channel bandwidth larger than the reference channel bandwidth. It should only allocate the required channel bandwidth, and select the reference bandwidth or even a smaller channel bandwidth for operation, using the action BWS. For example, if radio system 20C does not require more bandwidth than reference channel bandwidth 22, it should not consume more. However, if radio system 20C needs to transmit a large quantity of data, it can consume its normal bandwidth as shown in FIG. 1. Thus, this rule limits a bandwidth consumption of a radio system such as a wide channel radio system 20C based on a bandwidth requirement thereof. This rule refers for example to adaptively changing a hopping sequence in Frequency Hopping (FH) spread spectrum radio systems, and may not apply if transmission powers are below a certain threshold, typically for UWB.

Rule #2: “Power Selection Rule”

Radio systems that operate with a channel bandwidth larger than the reference bandwidth (e.g., radio system 20C), should limit the transmission power down to a predefined level in order to limit the interference on other radio systems. Thus, a power consumption of a radio system is limited based on its bandwidth consumption. This is generally so that as bandwidth consumption of a radio system increases, its power consumption should decrease. This rule may be applied by radio system 20C, and those that apply spread spectrum, or UWB. In any event, it should be noted that the bandwidth selection rule and the power selection rule are complementary to each other. For example, if radio system 20C (or any other radio system that operates with spread spectrum or UWB) is not able to change its channel bandwidth according to the bandwidth selection rule, the power selection rule should apply.

Rule #3: “Channel Selection Rule”

A radio system will select a frequency channel of operation based on a proximity of the frequency channel of operation to an in-use frequency channel of operation. Specifically, when making a decision about the frequency channel switching, a radio system such as radio system 20B should prefer a frequency channel that is in the spectrum close to other type 20B frequency channels, in order to minimize the number of reference channels that are interfered. This is here referred to as grouping. This rule may apply only in the presence of radio systems with a reference channel bandwidth 22 (identified through interferences on neighboring channels that are mutually correlated in time), or may always apply, independently of the presence of other radio systems. Grouping can be achieved by using a predefined list of preferred frequency channels. For example, radio system 20B may always select f₁ as initial frequency channel of operation, and if this channel is being used already, radio system 20B next attempts to operate on frequency channel f₂. If this frequency channel is also allocated, it may continue to select the next neighboring channel until a free frequency channel is found.

Rule #4: “Deferred Listen Before talk (LBT) Rule”

Under this rule, radio systems 20A, 20B and/or 20C should apply LBT when operating. For example, before communicating, radio systems 20A and/or 20B should “scan” for an open channel.

Rule #5: “Channelized LBT Rule”

This rule is related to the deferred LBT rule and generally applies to narrow channel radio systems such as radio system 20B and requires that the applicable radio systems scan the complete reference channel bandwidth 22, and not only the narrowband frequency channel on which it is operating. For example, if radio system 20B wishes to “talk” (communicate) on frequency channel f₂, it should scan f₁, f₂ and f₃ before doing so.

Rule #6: “Synchronized LBT Rule”

This rule is also based on the Deferred LBT Rule and also typically applies to narrowband radio systems such as radio system 20B. Specifically, in order to protect other radio systems most efficiently, radio system 20B (that follows the Deferred LBT Rule) should synchronize its LBT process in time across neighboring frequency channels (e.g., f₁, f₂ and f₃) that overlap with the same reference channel.

Based on the illustrative radio systems 20A-C shown in FIG. 2, the above rules apply as follows: (1) the Bandwidth Selection Rule and the Power Selection Rules apply to radio system 20C; (2) the Channel Selection Rule, the Channelized LBT rule and the synchronized LBT rule apply to radio system 20B; and (3) the Deferred LBT rule applies to radio systems 20A and 20B.

### EXPERIMENTAL EXAMPLE

In the following example, the Deferred LBT Rule, the Channelized LBT Rule and the Synchronized LBT Rule were evaluated. The results are discussed with respect to how reference channel radio system 20A was protected by these rules. Stochastic simulation of the usage model is used for this discussion.

In this example, one wide channel radio system such as radio system 20C of FIG. 2 (one broadband system with center frequency f₅, e.g., UWB hereinafter referred to as a type 20C radio system), three reference channel radio systems such as radio system 20A (three reference systems with center frequencies f₂, f₅ and f₈, e.g., 802.11 (a) hereinafter referred to as type 20A radio systems), and nine narrow channel radio systems such as radio system 20B radio systems (nine narrowband systems with one radio system per center frequency f₁. . . f₉ hereinafter referred to as type 20B radio systems), were simulated. Instead of modeling the detailed protocols, a simplified LBT was used for all radio systems. When a radio system wants to allocate radio resources, it scans its frequency channel to determine if it is busy or idle. The scanning is performed instantaneously, without delays. However, a type 20A radio system requires the respective three frequency channels to be idle before allocating radio resources. The type 20C radio system requires even the whole spectrum to be idle before allocating radio resources, hence, LBT is not proposed for this broadband radio system as a spectrum etiquette rule as indicated above.

Only if the respective channel(s) are idle, does a radio system allocates radio resources, otherwise it continues to scan until the channel(s) become idle. Collisions of allocation attempts occur when more than one radio system detects the channel as idle at the same time. In the simulation scenario, a perfect collision avoidance among resource allocations from different radio systems is assumed: if two or more radio systems attempt to allocate (use, occupy) the same radio resources (for example a type 20B radio system operating on frequency channel fi, and a type 20A radio system operating on and scanning frequency channels f₁-f₃), one of the radio systems is randomly selected to allocate the radio resource, the other radio systems defer and continue scanning the channel. This method to model the collision avoidance approximates a backoff window with an infinite number of slots, each slot having an infinitesimally small duration.

Further, a perfect channel is assumed so that a channel is either busy or idle. Radio systems always detect radio resource allocations of other radio systems. With respect to traffic model all radio systems were always offered the same traffic. The offered traffic is modeled with two random processes per radio system: the inter-arrival times are negative-exponentially distributed, with varying mean time, varied between 0 and 0.7. The radio resource access durations are uniformly distributed between 0 ms and 2 ms (1 ms=1 millisecond). In the idealized simulation scenario, there is no scan time, as the scanning is performed instantaneously.

In calculating the results, average airtime per radio system type is provided. Airtime refers to the ratio of allocation time per radio system type to simulation time:

$${airtime}_{typeA , B , C} = \frac{1}{{N}_{type}} {\sum }_{i = 1}^{{N}_{type}} \frac{allocationtime ( i )}{simulationtime}$$

with N_{A}=3, N_{B}=9, and N_{C}=1. The airtime characterizes the share of resources a radio system can allocate.

It should be understood that the term “allocation time(i)” refers to the cumulative time the radio system “i” allocates radio resources. Note that this is not attempting to show the throughput per radio system. Because the radio systems operate with different channel bandwidths, they will obtain different throughputs. This example focused on mutual influence of the radio systems on each other, which is indicated in the shown results.

A. Results for the Deferred LBT Rule

FIG. 3 illustrates the resulting airtime per radio system, averaged over the radio systems of the three different types 20A-C. All radio systems performed LBT. It can be seen in FIG. 3 that LBT is a measure that is most beneficial for the narrowband radio systems (type 20B). With increasing offered traffic, the narrowband radio systems (type 20B) achieve a larger airtime, and suppress the resource allocations of the other radio systems. Clearly, LBT alone is not a sufficient mechanism to achieve a fair share of radio resources. To mitigate this unwanted effect, two modifications of the LBT scheme are proposed, according to the Channelized LBT Rule and the Synchronized LBT Rule.

B. Results for the Channelized LBT Rule

One modification of the Deferred LBT Rule under the present invention is to require narrowband systems to scan the reference channels instead of their individual channels (i.e., the Channelized LBT Rule). With this modification, for example, a type 20B radio system operating at frequency channel f₁ would scan the three frequency channels f₁-f₃. Only if all the three channels are idle at the same time, the type B radio system may initiate a resource allocation, similar to type A radio systems. The results of this modification are shown in FIG. 4. It can be seen that this modification has negative implications on the airtime of the narrowband radio systems (type 20B), and improves the resulting airtime of the reference systems (type A) slightly, compared to FIG. 3. Note that the type 20B radio systems still achieve a significant advantage compared to the type 20A radio systems, because they still may transmit at the same time. Type 20B radio systems do not contend with each other during backoff. Thus, if one type 20B radio system allocates resources, type 20A radio systems have to defer, but type 20B radio systems may initiate a parallel resource allocation at the same time (starting at virtually the same time).

C. Results for the Synchronized LBT Rule

The second modification of the Deferred LBT Rule of the narrowband radio systems (type 20B) is to synchronize the radio resource allocations in time according to the Synchronized LBT Rule discussed above. If the narrowband radio systems allocate resources synchronously, the type 20A radio systems obtain a higher probability of scanning the three narrowband channels as idle at the same time. FIG. 5 shows the results. It can be seen that now the reference radio systems (type 20A), are better protected than before, and achieve a larger share. Therefore, synchronizing the radio resource allocations of neighboring narrowband radio systems, as discussed in the “Synchronized LBT Rule,” may help to control the radio resource allocations of coexisting radio systems that operate with different channel bandwidths.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims. For example, although the 5 GHz frequency band was discussed in conjunction with FIGS. 1-5, it should be understood that the set of spectrum etiquette rules can be applied to any unlicensed frequency band such as the 2.4 GHz band.

1. A system for coordinating radio resource usage in an unlicensed frequency band, comprising:
a plurality of radio systems (20A-C) operating in the unlicensed frequency band (24); and
a set of spectrum etiquette rules for coordinating radio resource usage by the plurality of radio systems (20A-C), wherein the set of spectrum etiquette rules includes a channel switching rule for determining a frequency channel of operation for at least one of the plurality of radio systems (20B) based on a proximity of the frequency channel of operation to an in-use frequency channel of operation that is associated with the at least one of the plurality of radio systems (20B)

2. The system of claim 1, wherein the set of spectrum etiquette rules further includes a bandwidth selection rule for limiting a bandwidth consumption of the plurality of radio systems (20A-C) to a reference channel bandwidth based on a bandwidth requirement of the plurality of radio systems (20A-C), wherein each of the plurality of radio systems (20A-C) will have a bandwidth consumption less than the reference channel bandwidth unless they require more bandwidth than the reference channel bandwidth.

3. The system of claim 2, wherein the set of spectrum etiquette rules further includes a power selection rule for limiting a power consumption of the plurality of radio systems (20A-C) to a predetermined level based on the bandwidth consumption, wherein the power consumption is inversely proportional to the bandwidth consumption.

4. The system of claim 1, wherein the set of spectrum etiquette rules further includes a deferring listen before talk (LBT) rule for requiring the plurality of radio systems (20A-C) to scan for an open frequency channel before communicating.

5. The system of claim 1, wherein the set of spectrum etiquette rules further includes a channelized LBT rule for requiring the at least one of the plurality of radio systems (20B) to scan all frequency channels (f₁-f₃) within a reference channel bandwidth (22) before communicating.

6. The system of claim 1, wherein the set of spectrum etiquette rules further includes a synchronized LBT rule for requiring the at least one of the plurality of radio systems (20B) to synchronize a LBT process in time across neighboring frequency channels (f₁-f₃) within the reference channel bandwidth (22).

7. The system of claim 1, wherein the plurality of radio systems (20A-C) comprises a reference channel radio system (20A), a narrow channel ratio system (20B) and a wide channel radio system (20C), and wherein the at least one radio system (20B) includes the narrow channel radio system (20B).

8. A system for coordinating radio resource usage in an unlicensed frequency band, comprising:
a plurality of radio systems (20A-C), wherein the plurality of radio systems (20A-C) includes a reference channel radio system (20A), a narrow channel ratio system (20B) and a wide channel radio system (20C), and wherein a reference channel bandwidth (22) is defined based on the reference channel radio system (20A); and
a set of spectrum etiquette rules for coordinating radio resource usage by the plurality of radio systems (20A-C), wherein the set of spectrum etiquette rules includes a channel switching rule for determining a frequency channel of operation for the narrow channel radio system (20B) based on a proximity of the frequency channel of operation to an in-use frequency channel of operation that is associated with the narrow channel radio system (20B).

9. The system of claim 8, wherein the set of spectrum etiquette rules further includes a bandwidth selection rule for limiting a bandwidth consumption of the wide channel radio system (20C) to the reference channel bandwidth (22) based on a bandwidth requirement of the wide channel radio system (20C), wherein the wide channel radio system will have a bandwidth consumption less than the reference channel bandwidth (22) unless the wide channel radio system (20C) requires more bandwidth than the reference channel bandwidth (22).

10. The system of claim 9, wherein the set of spectrum etiquette rules further includes a power selection rule for limiting a power consumption of the wide channel radio system (20C) to a predetermined level based on the bandwidth consumption, wherein the power consumption decreases as the bandwidth consumption increases.

11. The system of claim 8, wherein the set of spectrum etiquette rules further includes a deferring listen before talk (LBT) rule for requiring the reference channel radio system (20A) and the narrow channel radio system (20B) to scan for an open frequency channel before communicating.

12. The system of claim 8 wherein the set of spectrum etiquette rules further includes a channelized LBT rule for requiring the narrow channel radio system (20B) to scan all frequency channels (f₁-f₃) within the reference channel bandwidth (22) before communicating.

13. The system of claim 8, wherein the set of spectrum etiquette rules further includes a synchronized LBT rule for requiring the narrow channel radio system (20B) to synchronize a LBT process in time across neighboring frequency channels (f₁-f₃) within the reference channel bandwidth (22).

14. A method for coordinating radio resource usage in an unlicensed frequency band, comprising:
defining a reference channel bandwidth (22) based on a reference channel radio system (20A); and
determining a frequency channel of operation for a narrow channel radio system (20B) based on a proximity of the frequency channel of operation to an in-use frequency channel of operation that is associated with the narrow channel radio system (20B).

15. The method of claim 14, further comprising limiting a bandwidth consumption of a wide channel radio system (20C) to the reference channel bandwidth (22) based on a bandwidth requirement of the wide channel radio system (20C), wherein the bandwidth consumption of the wide channel radio system (20C) will be less than the reference channel bandwidth (22) unless the wide channel radio system (20C) requires more bandwidth than the reference channel bandwidth (22).

16. The method of claim 15, further comprising limiting a power consumption of the wide channel radio system (20C) to a predetermined level based on the bandwidth consumption, wherein the power consumption of the wide channel radio system (20C) decreases as the bandwidth consumption increases.

17. The method of claim 14, further comprising requiring the reference channel radio system (20A) and the narrow channel radio system (20B) to scan for an open frequency channel before communicating.

18. The method of claim 14, further comprising requiring the narrow channel radio system (20B) to scan all frequency channels (f₁-f₃) within the reference channel bandwidth (22) before communicating.

19. The method of claim 14, further comprising requiring the narrow channel radio system (20B) to synchronize a listen before talk (LBT) process in time across neighboring frequency channels (f₁-f₃) within the reference channel bandwidth (22).

20. The method of claim 14, wherein the frequency channel of operation for the narrow channel radio system is adjacent to the in-use frequency channel of operation.

21. A radio device operating in an unlicensed frequency band, comprising:
means for enacting a set of spectrum etiquette rules for coordinating radio resource usage by the radio device, wherein the set of spectrum etiquette rules includes a channel switching rule for determining a frequency channel of operation for the radio device based on a proximity of the frequency channel of operation to an in-use frequency channel of operation that is associated with the radio device.

22. The radio device of claim 1, wherein the means for enacting a set of spectrum etiquette rules further includes a means for enacting a bandwidth selection rule for limiting a bandwidth consumption of the radio device to a reference channel bandwidth based on a bandwidth requirement of a plurality of radio systems (20A-C), wherein each of the plurality of radio systems (20A-C) will have a bandwidth consumption less than the reference channel bandwidth unless they require more bandwidth than the reference channel bandwidth.

23. The radio device of claim 2, wherein the means for enacting a set of spectrum etiquette rules further includes means for enacting a power selection rule for limiting a power consumption of the radio device to a predetermined level based on the bandwidth consumption, wherein the power consumption is inversely proportional to the bandwidth consumption.

24. The radio device of claim 1, wherein the means for enacting a set of spectrum etiquette rules further includes means for enacting a deferring listen before talk (LBT) rule for requiring the radio device to scan for an open frequency channel before communicating.

25. The radio device of claim 1, wherein the means for enacting a set of spectrum etiquette rules further includes a means for enacting a channelized LBT rule for requiring the radio device to scan all frequency channels (f₁-f₃) within a reference channel bandwidth (22) before communicating.

26. The radio device of claim 1, wherein the means for enacting a set of spectrum etiquette rules further includes a means for enacting a synchronized LBT rule for requiring the radio device to synchronize a LBT process in time across neighboring frequency channels (f₁-f₃) within the reference channel bandwidth (22).

27. The radio device of claim 1, wherein the radio device further comprises at least one radio system (20B) which includes a narrow channel radio system (20B).

28. The radio device of claim 1, wherein the radio device is a reference channel radio (20A) and a reference channel bandwidth (22) is defined based on the reference channel radio (20A).

29. The radio device of claim 1, wherein the radio device is a narrow channel radio (20B).

30. The radio device of claim 1, wherein the radio device is a wide channel radio (20C).
